(19) United States
(12) Patent Application Publication
(10) Pub. No.: US 2009/0296905 A1
(43) Pub. Date: Dec. 3, 2009

(54) TELEPHONE SYSTEM AND GROUP PICKUP PROCESSING METHOD

(75) Inventor: Yoichi Naito, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/415,739

(22) Filed: Mar. 31, 2009

(30) Foreign Application Priority Data
May 30, 2008 (JP) 2008-143363

(51) Int. Cl. H04M 15/06

(52) U.S. Cl. 379/142.04

(57) ABSTRACT

According to one embodiment, a telephone system includes a plurality of telephone exchange apparatuses being connected to a communication network, and include telephone terminals, a memory stores a group table indicating correlation between groups made by dividing the telephone terminals, terminal IDs to specify telephone terminals belonging to the groups, and node IDs to specify the telephone exchange apparatus, an acquisition module refers to the group table, and acquire information about an incoming call including a node ID and a corresponding group terminal ID. For two or more candidates, from a telephone exchange apparatus belonging to a corresponding group, based on the reference result, and a controller selects a telephone terminal corresponding to information about an arbitrary incoming call from the information about candidate incoming calls obtained from the acquisition module based on a preset condition, and pick up an incoming call to the selected telephone terminal.

### CROSS-REFERENCE TO RELATED APPLICATIONS

This application is based upon and claims the benefit of priority from Japanese Patent Application No. 2008-143363, filed May 30, 2008, the entire contents of which are incorporated herein by reference.

### BACKGROUND

1. Field

One embodiment of the present invention relates to a telephone system in which telephone exchange apparatus are connected through a communication network, and a group pickup processing method used in this telephone system.

2. Description of the Related Art

A networking system is adopted by a corporation having branch offices and sales offices, in which a telephone exchange apparatus is installed in each branch and sales office, and the telephone exchange apparatus are connected through a communication network such as a private line. In such a system, communication is possible between extensions of the same telephone exchange apparatus, and between extensions of different exchange apparatus. Likewise, an outgoing call can be made in the same telephone exchange apparatus and different exchange apparatus, or through a different exchange apparatus.

In the above system, call pickup service realized in a system consisting of one telephone exchange apparatus is examined.

As a technique related to the above service, a telephone answering control method, in which a call is pickup picked up across nodes, has been proposed (e.g. Jpn. Pat. Appln. KOKAI Publication No. 2007-243727).

However, in the above networking system, the operation for call pickup service specifying a group realized in a system consisting of one telephone exchange apparatus is not the same as for the service realized by one node.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram showing a first embodiment of a telephone system to support a group pickup related to the invention;

FIG. 2 is a functional block diagram showing connection between telephone exchange apparatus shown in FIG. 1;

FIG. 3 is a table showing an example of storage contents of a group table to be stored in a group member management module shown in FIG. 2;

FIG. 4 is a table showing an example of information to be collected by an other node information collection module shown in FIG. 2;

FIG. 5 is a table showing an example of incoming call information decided by an oldest incoming call information decision module shown in FIG. 2;

FIG. 6 is a table showing an example of data indicating correlation between a local node number, a remote node number, and a channel, which are stored in the group pickup processing module shown in FIG. 2;

FIG. 7 is a diagram showing an example of a system considered in the past;

FIG. 8 is a diagram showing another example of a system considered in the past;

FIG. 9 is a diagram for explaining execution of call pickup for a specified group, in the first embodiment;

FIG. 10 is a diagram for explaining degeneration when a communication failure occurs between nodes, in the first embodiment; and

FIG. 11 is a flowchart showing control blocks of a group pickup processing module of a telephone exchange apparatus in a second embodiment of the invention.

### DETAILED DESCRIPTION

Various embodiments according to the invention will be described hereinafter with reference to the accompanying drawings. In general, according to one embodiment of the invention, a telephone system comprising: a plurality of telephone exchange apparatuses whose are connected to a communication network, and include telephone terminals; a memory which stores a group table indicating correlation between groups made by dividing the telephone terminals, terminal IDs to specify telephone terminals belonging to the groups, and node IDs to specify the telephone exchange apparatus; an acquisition module configured to refer to the group table, and acquire information about an incoming call including a node ID and a corresponding group terminal ID, for two or more candidates, from a telephone exchange apparatus belonging to a corresponding group, based on a reference result of the group table, when a pickup start request specifying a group occurs; and a controller which selects a telephone terminal corresponding to information about an arbitrary incoming call from the information about candidate incoming calls obtained from the acquisition module based on a preset condition, and pick up an incoming call to the selected telephone terminal.

### Embodiment 1

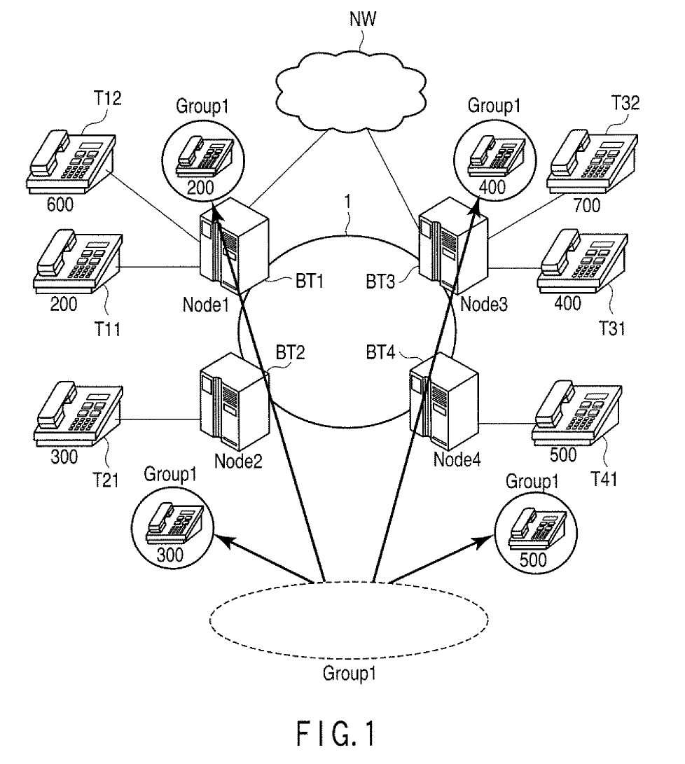

FIG. 1 is a schematic diagram showing a first embodiment of a telephone system to support a group pickup related to the invention.

This system has a private line 1 as a communication network. The private line 1 is connected to telephone exchange apparatuses BT1 to BT3. The telephone exchange apparatus BT1 is connected to telephone terminals T11 (telephone number 200) and T12 (telephone number 600), for example. The telephone exchange apparatus BT2 is connected to a telephone terminal T21 (telephone number 300), for example. The telephone exchange apparatus BT3 is connected to telephone terminals T31 (telephone number 400) and T32 (telephone number 700), for example. The telephone exchange apparatus BT4 is connected to a telephone terminal T41 (telephone number 500), for example.

The telephone exchange apparatus BT1 to BT4 have an ordinary exchange control function related to phone communication among the telephone terminals T11, T12, T21, T31, T32, and T41, and between a public network NW and telephone terminals T11, T12, T21, T31, T32, and T41.

The telephone terminals T11, T12, T21, T31, T32, and T41 are divided into two or more groups. The telephone terminals T11, T21, T31, and T41 belong to a group 1. The telephone terminal T12 belongs to a group 2. The telephone terminal T32 belongs to a group 5.

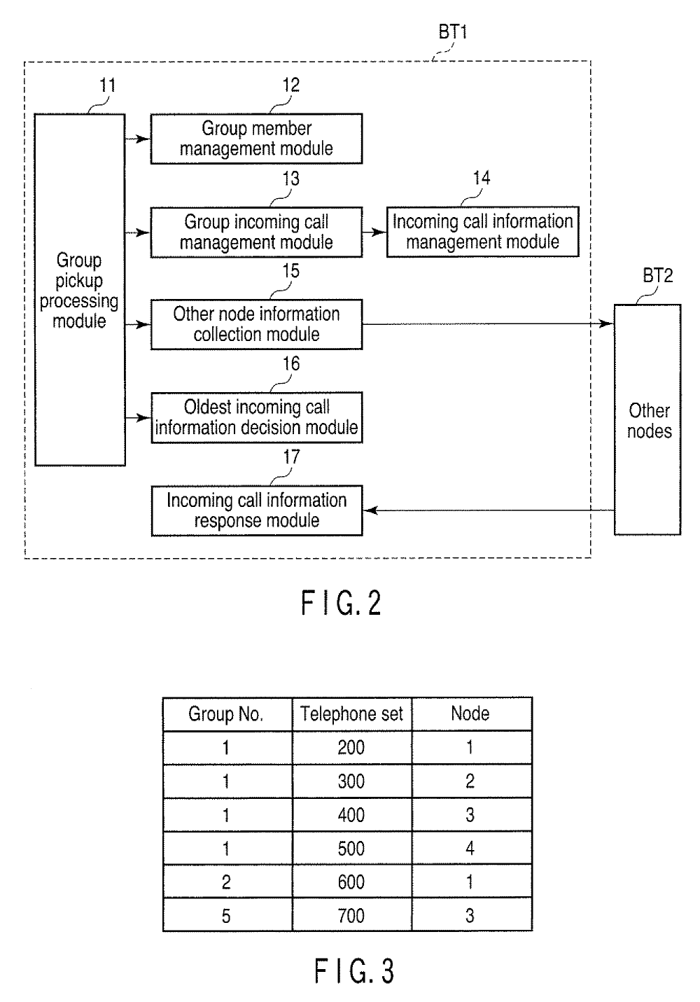

FIG. 2 is a functional block diagram showing connection between telephone exchange apparatus BT1 to BT4. Here, the telephone exchange apparatuses BT1 and BT2 are explained as representatives.

The telephone exchange apparatus BT1 has a group pickup processing module 11 (hereinafter, called a processing module 11), a group member management module 12 (hereinafter, called a management module 12), a group incoming call management module 13 (hereinafter, called a management module 14), an other node information collection module 15 (hereinafter, called a collection module 15), an oldest incoming call information decision module 16 (hereinafter, called a decision module 16), and an incoming call information response module 17 (hereinafter, called a response module 17), as functions related to the invention.

The processing module 11 receives a group pickup start request, requests other functions to execute respective functions, and connects an incoming call determined as a result.

The management module 12 stores a group table as a list of members belonging to a group. The group table is data indicating correlation between group numbers 1, 2 and 5 obtained by dividing the telephone terminals T11, T12, T21, T31, T32 and T41, telephone numbers (terminal IDs) of telephone terminals belonging to these groups 1, 2 and 5, and node IDs of telephone exchange apparatus, as shown in FIG. 3, for example.

The management module 13 collectively stores the information about an incoming call to a member in a node, or a member belonging to a corresponding group in the telephone exchange apparatus BT1. The information is obtained from the incoming call information management module 14.

The management module 14 manages the information about incoming calls at all telephone terminals T11 and T21 existing in a node, or the telephone exchange apparatus BT1.

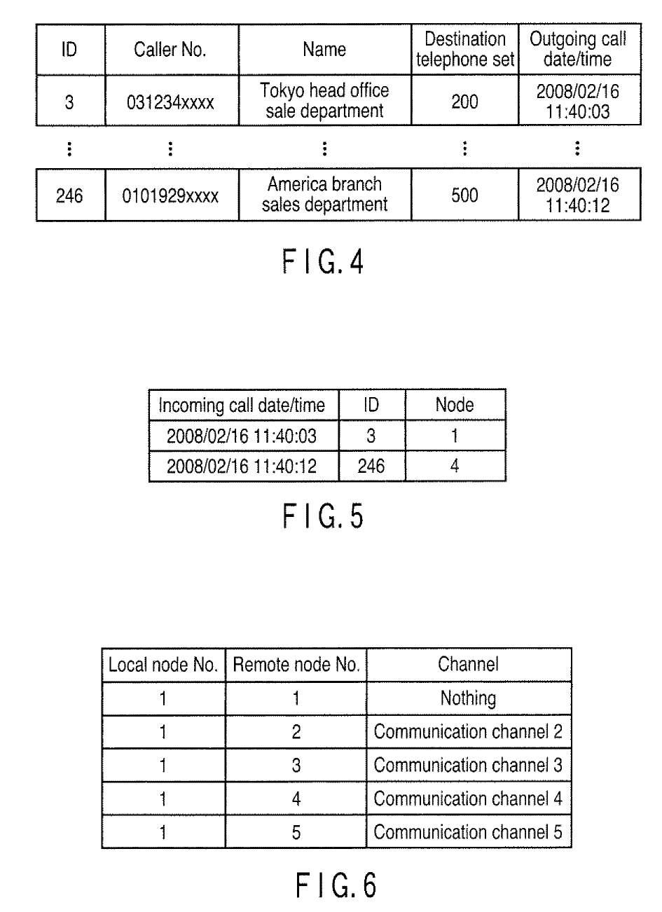

The collection module 15 requests other nodes to collect information. The collected information includes a caller's number and name, a destination telephone number, and an incoming call start date, for example, as shown in FIG. 4.

The decision module 16 decides an oldest incoming call from the collected incoming call information, as shown in FIG. 5. Here, incoming calls are reordered from the oldest one.

The response module 17 provides information for an information collection request related to incoming calls from other nodes.

The processing module 11 stores data indicating correlation between a local node number, a remote node number, and a channel, as shown in FIG. 6.

Next, an explanation will be given on the operation in the above system.

(Conventional System)

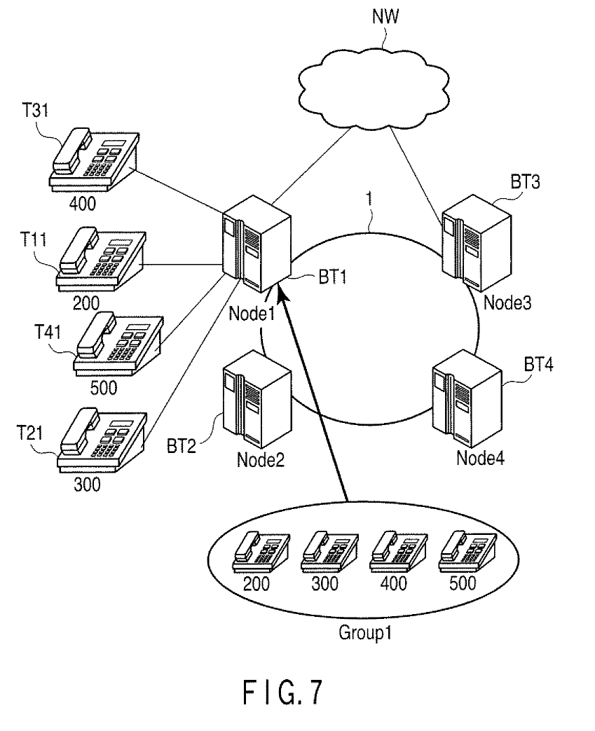

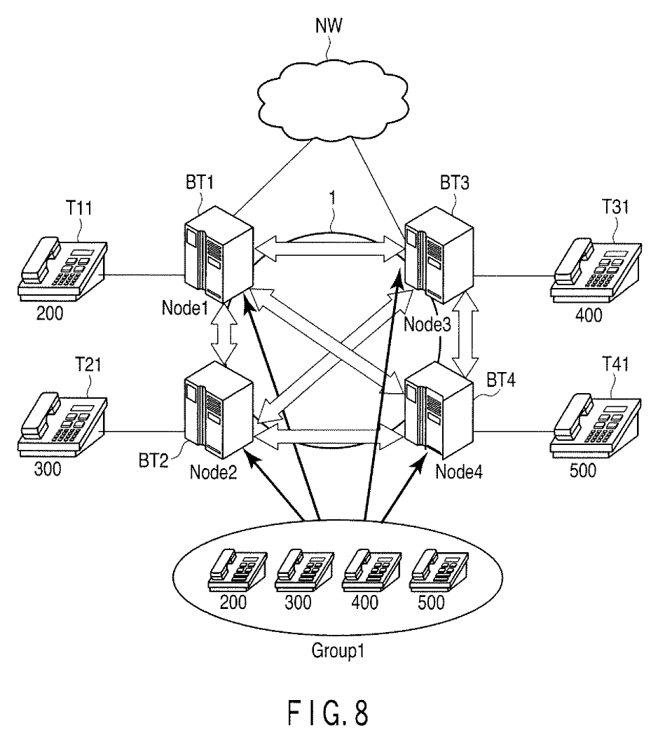

When a system consists of telephone exchange apparatuses BT1 to BT4, and group members are arranged across the telephone exchange apparatuses BT1 to BT4, generally, no service is provided for the group as shown in FIG. 7, or information is frequently exchanged for providing service as shown in FIG. 8.

In the case of FIG. 7, a customer has to arrange telephone sets by considering both group members and actual telephone sets, and cannot satisfy everything if there are two or more groups, and has to limit the service.

In the case of FIG. 8, since information greater than the amount required to answer the user's operation has to be handled, high-performance parts are required, and the production cost and customer's communication infrastructure cost for connection between nodes are increased.

Taking a group pickup as an example, when the telephone terminals T11, T21, T31 and T41 belong to the group 1, it is necessary to provide all of the telephone terminals T11, T21, T31 and T41 in the same telephone exchange apparatus BT1 in the case of FIG. 7.

In the case of FIG. 8, as the telephone terminals T11, T21, T31 and T41 are dispersed to the telephone exchange apparatuses BT1 to BT4, it is necessary to distribute the information about incoming calls occurred in the telephone exchange apparatuses BT1 to BT4, to all other servers.

### Operation in this Embodiment

Therefore, in this embodiment, necessary information is collected when it is required, even a group, in which members are assigned to telephone exchange apparatuses BT1 to BT4, can behave as if all telephone terminal T11, T21, T31 and T41 belong to one telephone exchange apparatus, without causing heavy communication traffic in a steady state.

First, a subgroup is assigned to each of the telephone exchange apparatuses BT1 to BT4. In a subgroup, information about incoming calls in the telephone exchange apparatuses BT1 to BT4, to which the subgroup belongs, is collected. For example, information about the telephone terminal T11 (telephone number 200) is collected in the telephone exchange apparatus BT1.

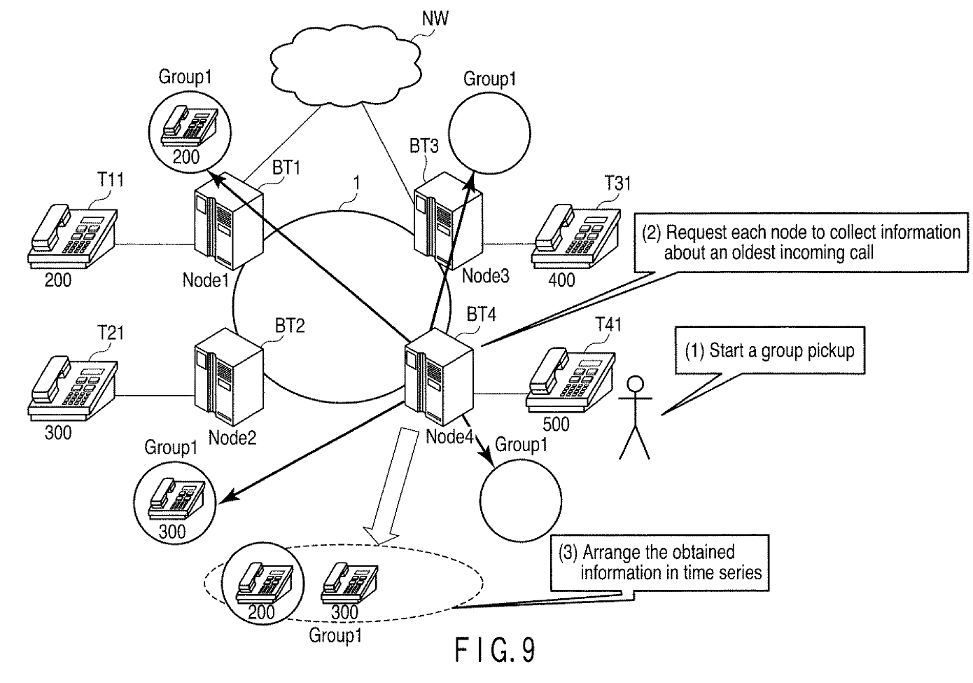

It is now assumed that the user starts a pickup specifying the group 1 in the telephone terminal T41, as shown in FIG. 9 ((1) in FIG. 9). Then, the request signal is sent from the telephone terminal T41 to the telephone exchange apparatus BT4.

Receiving the request signal, the telephone exchange apparatus BT4 requests all telephone exchange apparatuses BT1 to BT3 belonging to the group 1, to obtain information about an oldest incoming call ((2) in FIG. 9). Then, the telephone exchange apparatus BT4 arranges the obtained information in time series ((3) in FIG. 9). Namely, incoming calls are arranged in time order.

An oldest incoming call in the telephone exchange apparatus BT1 to BT3 is determined, and the oldest call is picked up. When an oldest call is attempted to answer, but it has already been answered, the next candidate call is selected from the incoming calls arranged in time series.

(Degeneration when Communication Failures Between Nodes)

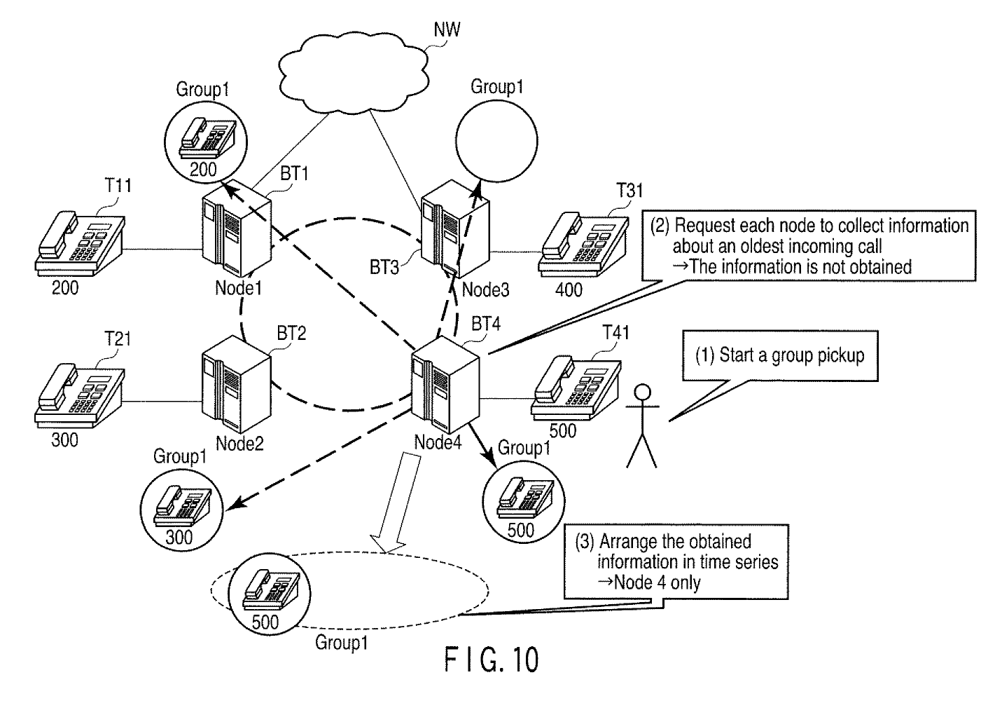

It is assumed that communication is not established between the telephone exchange apparatus BT4 that is a group pickup request source and the other telephone exchange apparatuses BT1 to BT3, as shown in FIG. 10. Since the telephone exchange apparatus BT4 cannot communicate with the telephone exchange apparatuses BT1 to BT3, there is no means of collecting an incoming call even if an incoming call occurs in the telephone exchange apparatuses BT1 to BT3. Thus, the service is provided only by the information in the telephone exchange apparatus BT4.

In the example of FIG. 10, an incoming call occurs in the telephone exchange apparatuses BT1 and BT2, but as the communication between the nodes is shut off, the telephone exchange apparatus BT4 cannot get the information about the incoming call. Thus, the group pickup in the telephone exchange apparatus BT4 is started only by the information about the incoming call in the telephone exchange apparatus BT4.

As described above, in the first embodiment, the management module 12 stores a group table indicating correlation between the groups, telephone numbers specifying the telephone terminals T11, T12, T21, T31, T32 and T41, and node IDs specifying the telephone exchange apparatuses BT1 to BT4. Therefore, when a pickup start request specifying the group 1 occurs in the telephone terminal T41, the processing module 11 refers to the group table, instructs the collection module 15 to get information about an oldest incoming call of a group member, from the telephone exchange apparatuses BT1 to BT3 belonging to the specified group 1, and executes the pickup operation by selecting further information about an oldest incoming call from the information about candidates incoming calls obtained from the telephone exchange apparatuses BT1 to BT3.

Therefore, the user of the telephone terminal T41 can execute a group pickup without considering arrangement of a specified group member in the telephone exchange apparatuses BT1 to BT4. Besides, as only the information about an oldest incoming call is obtained from the telephone exchange apparatuses BT1 to BT3 belonging to a specified group, the information amount transferred on the private line 1 is decreased, therefore the efficiency in determining an incoming call to be picked up can be further increased. As only the least necessary information is transferred on the private line 1, the information amount transferred on the private line 1 is decreased, therefore the efficiency in using the private line 1 can be further increased.

Besides, in the first embodiment, even if a connection failure occurs between the telephone exchange apparatuses BT1 to BT4, service can be provided in a degenerated state only by the information about an incoming call obtained from the normal telephone exchange apparatus BT1, or only by the telephone exchange apparatus BT4 that is a pickup request source.

### Embodiment 2

In the second embodiment, information about an incoming call of a group member is obtained from the telephone exchange apparatuses BT1 to BT4 belonging to a specified group, without conditioning information about an incoming call obtained from the telephone exchange apparatuses BT1 to BT4.

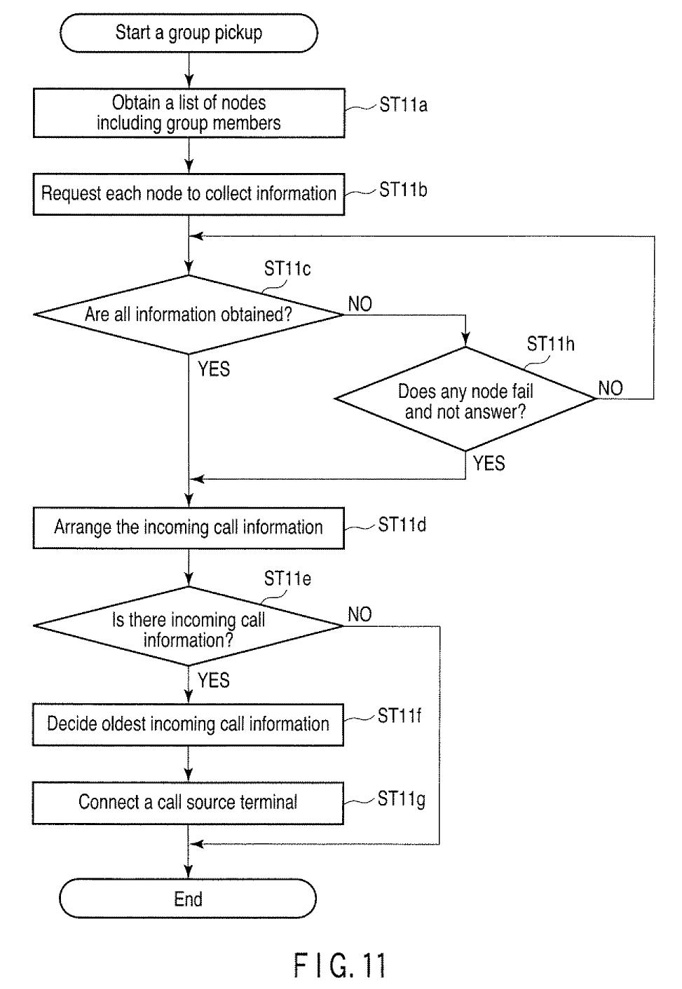

FIG. 11 is a flowchart showing control blocks of the processing module 11 of telephone exchange apparatuses BT1 to BT4.

It is assumed that the user actuates a pickup specifying a group 1 in the telephone terminal T41. A signal for the request is transmitted from the telephone terminal T41 to the telephone exchange apparatus BT4.

Receiving the request signal, the processing module 11 of the telephone exchange apparatus BT4 obtains a group table from the management module 12 (block ST11a), and instructs the collection module 15 to collect information about an incoming call in a group member for the telephone exchange apparatuses BT1 to BT3 belonging to the group 1, by referring to the group table (block ST11b), and determines whether the information about incoming calls in all group members is obtained from the telephone exchange apparatuses BT1 to BT3 within a certain time (block ST11c).

When the information about incoming calls in all group members are obtained (YES), the processing module 11 arranges the obtained information in time series (block ST11d), shifts from block ST11e to block ST11f, determines an oldest incoming call in the telephone exchange apparatuses BT1 to BT3, and execute a pickup operation for the oldest incoming call, that is, connects the telephone terminal T41 to the terminal originating the call to the telephone terminal T11 corresponding to the information about the oldest incoming call (block ST11g). When an oldest incoming call is tried to answer, but the call has already been answered, the next candidate incoming call is selected from the incoming calls arranged in series.

In block ST11c, the processing module 11 determines whether any one of the telephone exchange apparatuses BT1 to BT3 belonging to the group 1 fails and does not answer (block ST11h), before obtaining the information about the incoming calls of all group members, and shifts to block ST11c if any answer is obtained within certain time (NO), and shifts to block ST11d if no answer is obtained within certain time (YES).

As described above, in the second embodiment, the same function and effect as those in the first embodiment can be obtained, and the user of the telephone terminal T41 can execute a group pickup without considering arrangement of a specified group member in the telephone exchange apparatuses BT1 to BT4. Besides, only when a pickup specifying the group 1 is invoked, information about an incoming call of a group member is obtained from the telephone exchange apparatuses BT1 to BT3 belonging to the specified group, only the least necessary information is transferred on the private line 1, and the private line 1 can be efficiently used.

### Other Embodiments

The invention is not limited to the above embodiments. For example, in the first and second embodiments, an example using an oldest incoming call is used as a condition has been explained. The invention is not limited to such an example. At least one of a latest incoming call, an incoming call from a specified caller, an incoming call to a specific talker, and language may be used. For example, when the user of the telephone terminal T41 is secretary to the president, a call coming into the telephone terminal T11 provided in the president's office may be picked up with the highest priority. Further, when the user of the telephone terminal T41 is a person speaking French, a call from a French customer coming into the telephone terminal T21 may be picked up with the highest priority.

Further, in the first and second embodiments, the functions of storing a group table, obtaining information about an incoming call, and executing a group pickup are executed by the telephone exchange apparatuses BT1 to BT4. The invention is not limited to such cases. The functions of storing a group table, obtaining information about an incoming call, and executing a group pickup may be executed by a server or a terminal module connected to the private line 1 or at least one of the telephone exchange apparatuses BT1 to BT4.

Concerning a configuration and type of a system, a functional configuration and type of a telephone exchange apparatus, a type of a telephone terminal, and procedures and contents of control in collecting information about an incoming call, troubleshooting, and group pickup, the invention may be embodied in other specific forms without departing from its spirit and essential characteristics.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system comprising:
a plurality of telephone exchange apparatuses whose are connected to a communication network, and include telephone terminals;
a memory which stores a group table indicating correlation between groups made by dividing the telephone terminals, terminal IDs to specify telephone terminals belonging to the groups, and node IDs to specify the telephone exchange apparatus;
an acquisition module configured to refer to the group table, and acquire information about an incoming call including a node ID and a corresponding group terminal ID, for two or more candidates, from a telephone exchange apparatus belonging to a corresponding group, based on reference result of the group table, when a pickup start request specifying a group occurs; and
a controller which selects a telephone terminal corresponding to information about an arbitrary Incoming call from the information about candidate incoming calls obtained from the acquisition module based on a preset condition, and pick up an incoming call to the selected telephone terminal.

2. The telephone system of claim 1, wherein when a connection failure occurs between the telephone exchange apparatus and information about an incoming call is not obtained, the controller selects a telephone terminal corresponding to information about an arbitrary incoming call from the information about candidate incoming calls in a telephone exchange apparatus of a corresponding group, except the telephone exchange apparatus from which the information about an incoming call is not obtained, based on the preset condition, and picks up an incoming call to the selected telephone terminal.

3. The telephone system of claim 1, wherein when an incoming call to a selected telephone terminal is already answered, the controller selects a telephone terminal corresponding to information about the next candidate incoming call, and picks up an incoming call to the selected telephone terminal.

4. The telephone system of claim 1, wherein the controller uses at least one of an oldest incoming call, a latest incoming call, an incoming call from a specific caller, an incoming call to a specific user, and language, for determining the preset condition.

5. The telephone system of claim 1, wherein the acquisition module acquires information about an incoming call satisfying a preset condition, for two or more candidates.

6. The telephone system of claim 5, wherein the acquisition module uses at least one of an oldest incoming call, a latest incoming call, an incoming call from a specific caller, an incoming call to a specific user, and language, for determining the preset condition.

7. A group pickup processing method used in a telephone system including a plurality of telephone exchange apparatuses whose are connected to a communication network, and include telephone terminals, comprising:
storing a group table indicating correlation between groups made by dividing the telephone terminals, terminal IDs to specify telephone terminals belonging to the groups, and node IDs to specify the telephone exchange apparatus, in a memory;
referring to the group table, when a pickup start request specifying a group occurs;
acquiring information about an incoming call including a node ID and a corresponding group terminal ID, for two or more candidates, from a telephone exchange apparatus belonging to a corresponding group, based on reference result of the group table;
selecting a telephone terminal corresponding to information about an arbitrary incoming call from the information about obtained candidate incoming calls based on a preset condition; and
picking up an incoming call to the selected telephone terminal.
